(19) United States
(12) Patent Application Publication
(10) Pub. No.: US 2011/0193885 A1
(43) Pub. Date: Aug. 11, 2011

(54) ORGANIC LIGHT EMITTING DISPLAY

(75) Inventors: Kyung Ho LEE, Gyeonggi-do (KR); Kyoung Soo Kwon, Gyeonggi-do (KR)

(73) Assignee: SAMSUNG ELECTRO-MECHANICS CO., LTD.

(21) Appl. No.: 12/761,877

(22) Filed: Apr. 16, 2010

(30) Foreign Application Priority Data
Feb. 8, 2010 (KR) 10-2010-0011401

(51) Int. Cl. G09G 5/10

(52) U.S. Cl. 345/690; 345/77

(57) ABSTRACT

Disclosed herein is an organic light emitting display. The organic light emitting display is configured to include: a first transistor that receives a data signal from a data line in response to a scan signal from a scan signal line; a first capacitor that is charged with voltage corresponding to the data signal; a driving transistor that controls driving current supplied from a first power supply by corresponding to a voltage value charged in the first capacitor; a second transistor that connects or blocks the driving current transmitted through the driving transistor in response to an emission control signal from an emission control line; an organic light emitting diode that is connected between the second transistor and a second power supply and generates light corresponding to the driving current supplied from the driving transistor; and a reverse bias voltage applying module that reverses the polarity of the voltage supplied to the driving transistor simultaneously with applying reverse bias voltage to the organic light emitting diode in response to a reverse bias applying signal.

### CROSS REFERENCE TO RELATED APPLICATION

This application claims the benefit of Korean Patent Application No. 10-2010-0011401, filed on Feb. 8, 2010, entitled “Organic Light Emitting Display”, which is hereby incorporated by reference in its entirety into this application.

### BACKGROUND OF THE INVENTION

1. Technical Field

The present invention relates to a technology to prevent organic light emitting diodes that constitute a pixel of an organic light emitting display from being degraded.

2. Description of the Related Art

An organic light emitting display has advantages of a thin thickness, a wide viewing angle, and a rapid response speed, etc., such that it has been spotlighted as a next generation flat panel display. Such an organic light emitting display controls the amount of current flowing onto organic light emitting diodes of each pixel, thereby controlling the brightness of each pixel and displaying an image. In other words, current corresponding to data voltage is supplied to the organic light emitting diode and the organic light emitting diodes are light-emitted corresponding to the supplied current. At this time, the applied data voltage has multi-stage value in a predetermined range so as to display gray scale.

In a general organic light emitting display, current flows from the anode of the organic light emitting diode to the cathode thereof only in one direction, such that a space charge (a depletion layer) is accumulated between a hole transfer layer (HTL) and an emitting layer (EML) or between electron transfer layer (ETL) and an emitting layer (EML) of an organic thin film. The current flowing onto the organic light emitting diodes (OLED) is reduced due to the accumulation of such a space charge and thus, the brightness of each pixel is reduced, such that the brightness of the organic light emitting display adopting the pixel circuit is gradually reduced as time elapses. This feature is called as the degradation of the organic light emitting diodes. The degradation of the organic light emitting diodes described above may not only gradually reduce the brightness of the organic light emitting display but also shorten the life span of the organic light emitting display. Further, such a degradation is not only generated in the organic light emitting diodes but also generated inside a driving transistor that drives the organic light emitting diodes.

In order to solve the problems, in the related art, a separate circuit module that can sense the degradation degree of the corresponding diode and compensate therefor is provided for each organic light emitting diode, thereby compensating for the degradation. However, when such a separate circuit is provided, the circuit has a constitution that more driving current is supplied as a compensation current according to the degradation degree of the organic light emitting diodes and thus more current is supplied to the degraded pixel. As a result, the degradation of the organic light emitting diodes is more accelerated. Further, when a separate circuit module is added as described above, the circuit constitution of the organic light emitting display becomes complex and power consumption becomes unnecessarily large.

### SUMMARY OF THE INVENTION

The present invention has been made in an effort to provide an organic light emitting display that can continuously relieve the degradation of an organic light emitting diode and a driving transistor by reversing the polarity of voltage supplied to the driving transistor simultaneously with applying reverse bias voltage to the organic light emitting diode in a section where the organic light emitting diode is not light-emitted.

An exemplary embodiment of the present invention provides an organic light emitting display including: a first transistor that receives a data signal from a data line in response to a scan signal from a scan signal line; a first capacitor that is charged with voltage corresponding to the data signal; a driving transistor that controls driving current supplied from a first power supply by corresponding to a voltage value charged in the first capacitor; a second transistor that connects or blocks the driving current transmitted through the driving transistor in response to an emission control signal from an emission control line; an organic light emitting diode that is connected between the second transistor and a second power supply and generates light corresponding to the driving current supplied from the driving transistor; and a reverse bias voltage applying module that reverses the polarity of the voltage supplied to the driving transistor simultaneously with applying reverse bias voltage to the organic light emitting diode in response to a reverse bias applying signal.

At this time, a first electrode of the first transistor may be connected to the data line and a second electrode of the first transistor may be connected to one terminal of the first capacitor and a control electrode of the driving transistor, and a control electrode of the first transistor may be connected to the scan signal line.

A first electrode of the driving transistor may be connected to the first power supply and the other terminal of the first capacitor, and a second electrode of the driving transistor may be connected to a first electrode of the second transistor.

Further, a second electrode of the second transistor may be connected to one terminal of the organic light emitting diode, and a control electrode of the second transistor may be connected to the emission control line.

Meanwhile, the reverse bias voltage applying module may include: a first switch that is connected between the other terminal of the first capacitor and the first electrode of the driving transistor to connect or block a connection between the first capacitor and the first electrode of the driving transistor; a second capacitor of which one terminal is connected to the other terminal of the first transistor; a second switch that is connected between the other terminal of the second capacitor and the second electrode of the driving transistor to connect or block a connection between the second capacitor and the second electrode of the driving transistor; a third switch that is connected between the second electrode of the driving transistor and the first power supply to connect or block the supply of the first power supply voltage to the second electrode of the driving transistor; and a fourth switch that is connected between a reverse bias power supply and one terminal of the organic light emitting diode to connect or block the reverse bias voltage applied to the organic light emitting diode.

At this time, when the reverse bias applying signal is applied to the reverse bias voltage applying module, the first switch may be turned off and the second to fourth switches may be turned on.

When the reverse bias applying signal is applied to the reverse bias voltage applying module, second power may be supplied to the first electrode of the driving transistor and first power may be supplied to the other terminal of the organic light emitting diode.

Meanwhile, when the reverse bias applying signal is not applied to the reverse bias voltage applying module, the first switch may be turned on and the second to fourth switches may be turned off.

The reverse bias applying signal may be applied in a section where the organic light emitting diode is not light-emitted.

Further, the second capacitor may have the same capacity as the first capacitor.

Meanwhile, the reverse bias voltage applying module may include: a first switch that is connected between the other terminal of the first capacitor and the first electrode of the driving transistor to connect or block a connection between the first capacitor and the first electrode of the driving transistor; a second switch that is connected between the other terminal of the first capacitor and the second electrode of the driving transistor to connect or block a connection between the first capacitor and the second electrode of the driving transistor; a third switch that is connected between the second electrode of the driving transistor and the first power supply voltage line to connect or block the supply of the first power supply voltage to the second electrode of the driving transistor; and a fourth switch that is connected between a reverse bias power supply voltage line and one terminal of the organic light emitting diode to connect or block the reverse bias voltage applied to the organic light emitting diode.

At this time, when the reverse bias applying signal is applied to the reverse bias voltage applying module, the first switch may be turned off and the second to fourth switches may be turned on.

When the reverse bias applying signal is applied to the reverse bias voltage applying module, second power may be supplied to the first electrode of the driving transistor and first power may be supplied to the other terminal of the organic light emitting diode.

Meanwhile, when the reverse bias applying signal is not applied to the reverse bias voltage applying module, the first switch may be turned on and the second to fourth switches may be turned off.

The reverse bias applying signal may be applied in a section where the organic light emitting diode is not light-emitted.

### BRIEF DESCRIPTION OF THE DRAWINGS

FIG. 1 is a circuit view of an organic light emitting display 100 according to a first embodiment of the present invention;

FIG. 2 shows an equivalent circuit in the case where a reverse bias applying signal is not applied to an organic light emitting display 100 according to an embodiment of the present invention;

FIG. 3 shows an equivalent circuit in the case where a reverse bias applying signal is applied to an organic light emitting display 100 according to an embodiment of the present invention;

FIG. 4 is a circuit view of an organic light emitting display 400 according to a second embodiment of the present invention;

FIG. 5 shows an equivalent circuit in the case where a reverse bias applying signal is not applied to an organic light emitting display 400 according to an embodiment of the present invention; and

FIG. 6 shows an equivalent circuit in the case where a reverse bias applying signal is applied to an organic light emitting display 400 according to an embodiment of the present invention.

### DESCRIPTION OF THE PREFERRED EMBODIMENTS

Hereinafter, exemplary embodiments of the present invention will be described with reference to the accompanying drawings. However, the invention may be embedded in many different forms and should not be construed as limited to the embodiments set forth herein.

In the following description, when it is determined that the detailed description of the conventional function and conventional structure would confuse the gist of the present invention, such a description may be omitted. And, terms used in the specification and claims herein are defined by considering the functions thereof in the present invention so that they may be varied according to a user's and an operator's intends or practices. Therefore, the definitions thereof should be construed based on the contents throughout the specification.

The technical idea of the present invention is determined by the claims and the exemplary embodiments herein are provided so that the technical idea of the present invention will be efficiently explained to those skilled in the art to which the present invention pertains.

### First Embodiment

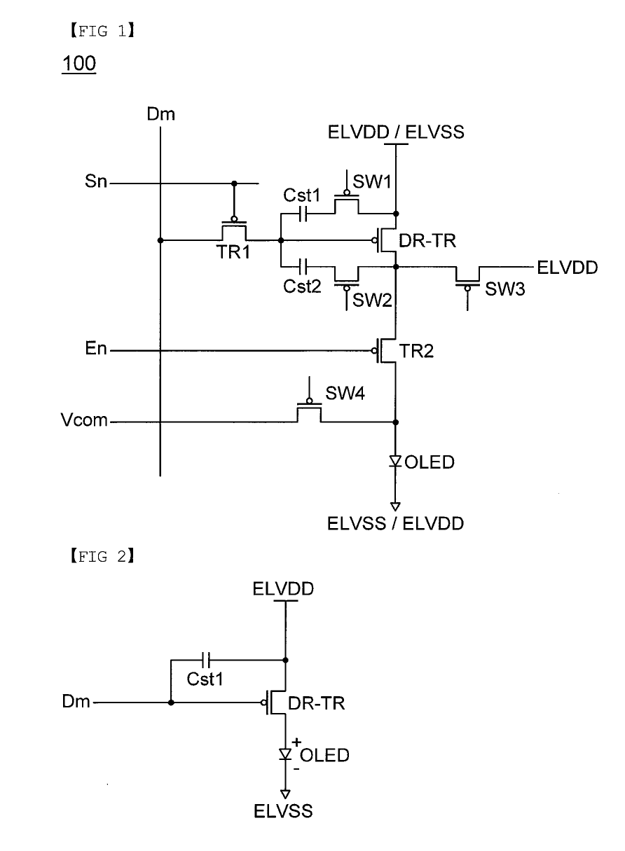

FIG. 1 is a circuit view of an organic light emitting display 100 according to a first embodiment of the present invention.

As shown in FIG. 1, an organic light emitting display 100 according to a first embodiment of the present invention may be configured to include a first transistor TR1, a first capacitor Cst1, a second capacitor Cst2, a driving transistor DR-TR, a second transistor TR2, an organic light emitting diode OLED, and first to fourth switches SW1, SW2, SW3, and SW4.

The first transistor TR1 includes a first electrode that is connected to a data line Dm, a second electrode that is connected to one terminal of the first capacitor Cst1, one terminal of the second capacitor Cst2, and a control electrode of the driving transistor DR-TR, and a control electrode that is connected to a scan signal line Sn. In the embodiments of the present invention, it should be noted that the meanings of “connected to” does not imply that elements are simply physically engaged but imply that they are electrically connected to each other through a conductor.

The first transistor connected as described above receives a data signal from the data line Dm in response to a scan signal supplied from the scan signal line Sn. In other words, the first transistor TR1 is turned on when the scan signal is supplied from the scan signal line Sn, and supplies the data signal supplied from the data line Dm to the driving transistor DR-TR, the first capacitor Cst1, and the second capacitor Cst2. The scan signal line Sn and the data line Dm described above, and an emission control signal line Em to be described later are constitutions commonly used in the technical fields to which the present invention pertains, such that their detailed description will be omitted.

The first capacitor Cst1, of which one terminal is connected to the second electrode of the first transistor TR1 and the other terminal is connected to a first electrode of the driving transistor DR-TR by the first switch SW1, receives the data signal from the first transistor TR1 and is charged with voltage corresponding to the data signal.

The driving transistor DR-TR includes a first electrode that is connected to the other terminal of the first capacitor Cst1 by the first switch SW1 and is supplied with first power voltage ELVDD, a second electrode that is connected to a first electrode of the second transistor, and a control electrode that is connected to the second electrode of the first transistor TR1. The driving transistor DR-TR connected as described above controls driving current supplied from a first power supply to the organic light emitting diode OLED by corresponding to a voltage value charged in the first capacitor Cst1.

The second transistor TR2 includes a first electrode that is connected to the second electrode of the driving transistor DR-TR, a second electrode that is connected to one terminal of the organic light emitting diode OLED, and a control electrode that is connected to an emission control line En. The second transistor TR2 connected as described above connects or blocks driving current supplied from the driving transistor DR-TR to the organic light emitting diode OLED in response to the emission control signal from the emission control line En. In other words, the second transistor TR2 is turned on when the emission control signal is supplied from the emission control line En, and supplies the driving current supplied from the driving transistor DR-TR to the organic light emitting diode OLED.

One terminal (anode) of the organic light emitting diode OLED is connected to the second electrode of the second transistor TR2 and the other terminal (cathode) thereof is connected to a second power supply ELVSS. At this time, the voltage value of the second power supply ELVSS is lower than that of the first power supply ELVDD. The organic light emitting diode OLED connected as described above receives the driving current from the driving transistor DR-TR and generates light corresponding thereto.

The first transistor TR1, the second transistor TR2, and the driving transistor DR-TR described above, that all are field effect transistors, may, for example, be constituted as a PMOS transistor or an NMOS transistor.

The first to fourth switches SW1, SW2, SW3, and SW4, and the second capacitor Cst2 perform functions to reverse the polarity of the voltage supplied to the driving transistor DR-TR simultaneously with applying reverse bias voltage to the organic light emitting diode OLED in response to the reverse bias applying signal, and they constitute a reverse bias voltage applying module in the embodiment of the present invention. The detailed constitution of the reverse bias voltage applying module will be described.

The first switch SW1 is connected between the other terminal of the first capacitor Cst1 and the first electrode of the driving transistor DR-TR to connect or block an electrical connection between the first capacitor Cst1 and the first electrode of the driving transistor DR-TR.

The second capacitor Cst2, that is a capacitor connected between the other terminal of the first transistor TR1 and the second switch SW2, may be constituted as a capacitor having the same capacity as the first capacitor Cst1.

The second switch SW2 is connected between the second capacitor Cst2 and the second electrode of the driving transistor DR-TR to connect or block a connection between the second capacitor Cst2 and the second electrode of the driving transistor DR-TR.

The third switch SW3 is connected between the second electrode of the driving transistor DR-TR and the first power supply ELVDD to connect or block the supply of the first power supply voltage ELVDD to the second electrode of the driving transistor DR-TR.

The fourth switch SW4 is connected between a reverse bias power supply voltage line Vcom and one terminal (anode) of the organic light emitting diode OLED to apply or block the reverse bias voltage to the organic light emitting diode OLED. The reverse bias voltage means voltage which is lower than voltage input into the cathode of the organic light emitting diode OLED. In the embodiment of the present invention, the reverse bias voltage means voltage which is lower than the voltage of the first power supply ELVDD.

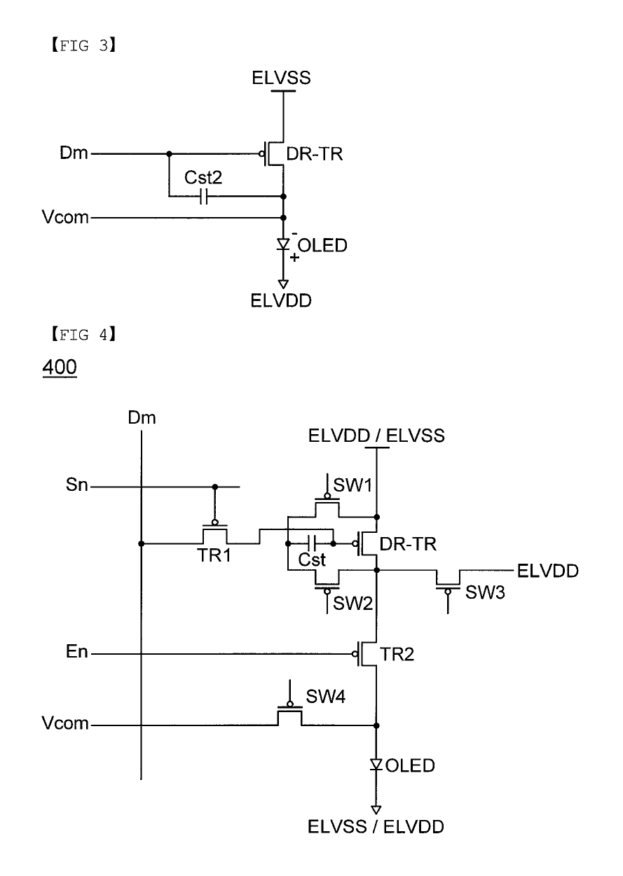

The reverse bias voltage applying module constituted as described above is driven according to the reverse bias applying signal. More specifically, when the reverse bias applying signal is applied to the reverse bias voltage applying module, the first switch is turned off and the second to fourth switches are turned on. Further, when the reverse bias applying signal is applied, the second power ELVSS is supplied to the first electrode of the driving transistor DR-TR to which the first power ELVDD is supplied and the first power ELVDD is supplied to the other terminal (cathode) of the organic light emitting diode OLED to which the second power ELVSS is supplied. Therefore, the reverse bias voltage is applied to the organic light emitting diode OLED, thereby making it possible to relieve the degradation of the organic light emitting diode, and at the same time, the voltage having opposite polarity is also applied to the driving transistor DR-TR, thereby making it also possible to prevent the degradation of the driving transistor DR-TR. Hereinafter, the detailed operation of the organic light emitting display 100 according to one exemplary embodiment of the present invention will be described with reference to FIGS. 2 and 3.

FIG. 2 shows an equivalent circuit in the case where a reverse bias applying signal is not applied to an organic light emitting display 100 according to an embodiment of the present invention, and FIG. 3 shows an equivalent circuit in the case where a reverse bias applying signal is applied to an organic light emitting display 100 according to an embodiment of the present invention.

When a reverse bias applying signal is not applied to the organic light emitting display 100, the first switch is turned on and the second to fourth switches are turned off. Therefore, in this case, the circuit shown in FIG. 1 may be represented by the equivalent circuit having the shape shown in FIG. 2. In this case, likewise a general organic light emitting display, the data signal is transmitted from the data line Dm and thus, light is emitted from the organic light emitting diode OLED.

Meanwhile, when a reverse bias applying signal is applied to the organic light emitting display 100, the first switch is turned off and the second to fourth switches are turned on, and the supply positions of the first power and the second power are reversed as described above. Therefore, in this case, the circuit shown in FIG. 1 may be represented by the equivalent circuit having the shape shown in FIG. 3.

As shown in FIG. 3, when the reverse bias applying signal is applied to the organic light emitting display 100, the first power ELVDD is applied to the cathode of the organic light emitting diode OLED and the reverse bias voltage which is lower than the first power ELVDD is applied to the anode thereof, such that the polarity of the voltage applied to the organic light emitting diode OLED is reversed. Therefore, the depletion layer inside the organic light emitting diode OLED is reduced while the reverse bias applying signal is applied, such that the degradation of the organic light emitting diode OLED is relieved.

Further, as shown in FIG. 3, the first power ELVDD is applied to the second electrode of the driving transistor DR-TR and the second power ELVSS is applied to the first electrode thereof, and the connection of the first capacitor Cst1 that is connected to the first electrode is blocked and the second capacitor Cst2 is instead connected to the second electrode of the driving transistor DR-TR. Therefore, the polarity of the driving transistor DR-TR is also reversely applied compared to the case when the organic light emitting diode OLED is light-emitted, such that the degradation of the driving transistor DR-TR can also be relieved.

The reverse bias applying signal described above may be applied only in a section where the screen of the organic light emitting display 100 is not displayed, that is, a section where the organic light emitting diode OLED is not light-emitted. For example, the reverse bias applying signal may be applied only in a section where the initial power of the organic light emitting display 100 is applied, a back-porch section, or a front-porch section. Alternatively, since the organic light emitting diode OLED is light-emitted only in the section where the emission control signal is applied from the emission control signal line En, the reverse bias applying signal may be applied by reversing the emission control signal. In other words, the reverse bias applying signal may not be applied in the section where the emission control signal is applied and the reverse bias applying signal may be applied in the section where the emission control signal is not applied.

### Second Embodiment

FIG. 4 is a circuit view of an organic light emitting display 400 according to a second embodiment of the present invention.

As shown in FIG. 4, an organic light emitting display 400 according to a second embodiment of the present invention may be configured to include a first transistor TR1, a capacitor Cst, a driving transistor DR-TR, a second transistor TR2, an organic light emitting diode OLED, and first to fourth switches SW1, SW2, SW3, and SW4. The organic light emitting display 400 according to the second embodiment of the present invention includes only one capacitor Cst, which is the only difference from the first embodiment that includes two capacitors, i.e., the first capacitor Cst1 and the second capacitor Cst2.

The first transistor TR1 includes a first electrode that is connected to a data line Dm, a second electrode that is connected to one terminal of the capacitor Cst and a control electrode of the driving transistor DR-TR, and a control electrode that is connected to a scan signal line Sn. The first transistor connected described above receives a data signal from the data line Dm in response to a scan signal supplied from the scan signal line Sn. In other words, the first transistor TR1 is turned on when the scan signal is supplied from the scan signal line Sn, and supplies the data signal supplied from the data line Dm to the driving transistor DR-TR and the capacitor Cst.

The capacitor Cst, of which one terminal is connected to the second electrode of the first transistor TR1 and the other terminal is connected to a first electrode of the driving transistor DR-TR by the first switch SW1, receives the data signal from the first transistor TR1 and is charged with voltage corresponding to the data signal.

The driving transistor DR-TR includes a first electrode that is connected to the other terminal of the capacitor Cst by the first switch SW1 and is supplied with first power voltage ELVDD, a second electrode that is connected to a first electrode of the second transistor, and a control electrode that is connected to the second electrode of the first transistor TR1. The driving transistor DR-TR connected as described above controls driving current supplied from a first power supply to the organic light emitting diode OLED by corresponding to a voltage value charged in the capacitor Cst.

The second transistor TR2 includes a first electrode that is connected to the second electrode of the driving transistor DR-TR, a second electrode that is connected to one terminal of the organic light emitting diode OLED, and a control electrode that is connected to an emission control line En. The second transistor TR2 connected as described above connects or blocks driving current supplied from the driving transistor DR-TR to the organic light emitting diode OLED in response to the emission control signal of the emission control line En. In other words, the second transistor TR2 is turned on when the emission control signal is supplied from the emission control line En, and supplies the driving current supplied from the driving transistor DR-TR to the organic light emitting diode OLED.

One terminal (anode) of the organic light emitting diode OLED is connected to the second electrode of the second transistor TR2 and the other terminal (cathode) thereof is connected to a second power supply ELVSS. At this time, the voltage value of the second power supply ELVSS is lower than that of the first power supply ELVDD. The organic light emitting diode OLED connected as described above receives the driving current from the driving transistor DR-TR and generates light corresponding thereto.

The first transistor TR1, the second transistor TR2, and the driving transistor DR-TR described above, that all are field effect transistors (MOSFET), may, for example, be constituted as a PMOS transistor or an NMOS transistor.

The first to fourth switches SW1, SW2, SW3, and SW4 perform functions to reverse the polarity of the voltage supplied to the driving transistor DR-TR simultaneously with applying reverse bias voltage to the organic light emitting diode OLED in response to the reverse bias applying signal, and they constitute a reverse bias voltage applying module in the embodiment of the present invention. The detailed constitution of the reverse bias voltage applying module will be described.

The first switch SW1 is connected between the other terminal of the capacitor Cst and the first electrode of the driving transistor DR-TR to connect or block an electrical connection between the capacitor Cst and the first electrode of the driving transistor DR-TR.

The second switch SW2 is connected between the other terminal of the capacitor Cst and the second electrode of the driving transistor DR-TR to connect or block an electrical connection between the capacitor Cst and the second electrode of the driving transistor DR-TR.

The third switch SW3 is connected between the second electrode of the driving transistor DR-TR and the first power supply ELVDD to connect or block the supply of the first power supply voltage ELVDD to the second electrode of the driving transistor DR-TR.

The fourth switch SW4 is connected between a reverse bias power supply voltage line Vcom and the other terminal (anode) of the organic light emitting diode OLED to apply or block the reverse bias voltage to the organic light emitting diode OLED. The reverse bias voltage means voltage which is lower than voltage input into the cathode of the organic light emitting diode OLED. In the embodiment of the present invention, the reverse bias voltage means voltage which is lower than the voltage of the first power supply ELVDD.

The reverse bias voltage applying module constituted as described above is driven according to the reverse bias applying signal. More specifically, when the reverse bias applying signal is applied to the reverse bias voltage applying module, the first switch is turned off and the second to fourth switches are turned on. Further, when the reverse bias applying signal is applied, the second power ELVSS is supplied to the first electrode of the driving transistor DR-TR to which the first power ELVDD is supplied and the first power ELVDD is supplied to the other terminal (cathode) of the organic light emitting diode OLED to which the second power ELVSS is supplied. Therefore, the reverse bias voltage is applied to the organic light emitting diode OLED, thereby making it possible to relieve the degradation of the organic light emitting diode, and at the same time, the voltage having opposite polarity is also applied to the driving transistor DR-TR, thereby making it also possible to prevent the degradation of the driving transistor DR-TR.

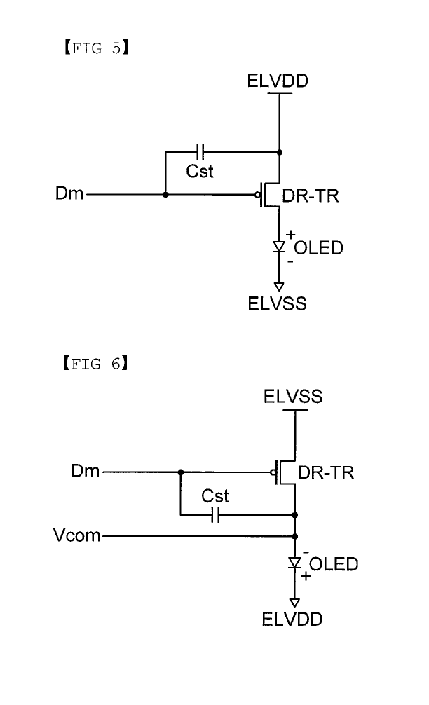

FIG. 5 shows an equivalent circuit in the case where a reverse bias applying signal is not applied to an organic light emitting display 400 according to an embodiment of the present invention, and FIG. 6 shows an equivalent circuit in the case where a reverse bias applying signal is applied to an organic light emitting display 400 according to an embodiment of the present invention.

When a reverse bias applying signal is not applied to the organic light emitting display 400, the first switch SW1 is turned on and the second to fourth switches SW2, Sw3, and SW4 are turned off. Therefore, in this case, the circuit shown in FIG. 4 may be represented by the equivalent circuit having the shape shown in FIG. 5. In this case, likewise a general organic light emitting display, the data signal is transmitted from the data line Dm and thus, light is emitted from the organic light emitting diode OLED.

Meanwhile, when a reverse bias applying signal is applied to the organic light emitting display 400, the first switch SW1 is turned off and the second to fourth switches SW2, SW3, and SW4 are turned on, and the supply positions of the first power and the second power are reversed as described above. Therefore, in this case, the circuit shown in FIG. 4 may be represented by the equivalent circuit having the shape shown in FIG. 6.

As shown in FIG. 6, when the reverse bias applying signal is applied to the organic light emitting display 400, first power ELVDD is applied to the cathode of the organic light emitting diode OLED and the reverse bias voltage which is lower than the first power ELVDD is applied to the anode thereof, such that the polarity of the voltage applied to the organic light emitting diode OLED is reversed. Therefore, the depletion layer inside the organic light emitting diode OLED is reduced while the reverse bias applying signal is applied, such that the degradation of the organic light emitting diode OLED is relieved.

Further, as shown in FIG. 6, the first power ELVDD is applied to the second electrode of the driving transistor DR-TR and the second power ELVSS is applied to the first electrode thereof, and the connection of the capacitor Cst that is connected to the first electrode is changed and thus, the capacitor Cst is connected to the second electrode of the driving transistor DR-TR. Therefore, the polarity of the driving transistor DR-TR is also reversely applied compared to the case when the organic light emitting diode OLED is light-emitted, such that the degradation of the driving transistor DR-TR can also be relieved.

The reverse bias applying signal described above may be applied only in a section where the screen of the organic light emitting display 400 is not displayed, that is, a section where the organic light emitting diode OLED is not light-emitted, as in the first embodiment. For example, the reverse bias applying signal may be applied only in a section where the initial power of the organic light emitting display 400 is applied, a back-porch section, or a front-porch section. Alternatively, since the organic light emitting diode OLED is light-emitted only in the section where the emission control signal is applied from the emission control signal line En, the reverse bias applying signal may be applied by reversing the emission control signal. In other words, the reverse bias applying signal may not be applied in the section where the emission control signal is applied and the reverse bias applying signal is applied in the section where the emission control signal is not applied.

According to exemplary embodiments of the present invention, the polarity of the voltage supplied to the driving transistor is reversed simultaneously with applying the reverse bias voltage to the organic light emitting diode in the section where the organic light emitting diode is not light-emitted, thereby making it possible to prevent the degradation of the driving transistor as well as the organic light emitting diode.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the appended claims and their equivalents.

What is claimed is:

1. An organic light emitting display, comprising:
a first transistor that receives a data signal from a data line in response to a scan signal from a scan signal line;
a first capacitor that is charged with voltage corresponding to the data signal;
a driving transistor that controls driving current supplied from a first power supply by corresponding to a voltage value charged in the first capacitor;
a second transistor that connects or blocks the driving current transmitted through the driving transistor in response to an emission control signal from an emission control line;
an organic light emitting diode that is connected between the second transistor and a second power supply and generates light corresponding to the driving current supplied from the driving transistor; and
a reverse bias voltage applying module that reverses the polarity of the voltage supplied to the driving transistor simultaneously with applying reverse bias voltage to the organic light emitting diode in response to a reverse bias applying signal.

2. The organic light emitting display according to claim 1, wherein a first electrode of the first transistor is connected to the data line and a second electrode of the first transistor is connected to one terminal of the first capacitor and a control electrode of the driving transistor, and a control electrode of the first transistor is connected to the scan signal line.

3. The organic light emitting display according to claim 2, wherein a first electrode of the driving transistor is connected to the first power supply and the other terminal of the first capacitor, and a second electrode of the driving transistor is connected to a first electrode of the second transistor.

4. The organic light emitting display according to claim 3, wherein a second electrode of the second transistor is connected to one terminal of the organic light emitting diode, and a control electrode of the second transistor is connected to the emission control line.

5. The organic light emitting display according to claim 4, wherein the reverse bias voltage applying module includes:
a first switch that is connected between the other terminal of the first capacitor and the first electrode of the driving transistor to connect or block a connection between the first capacitor and the first electrode of the driving transistor;
a second capacitor of which one terminal is connected to the other terminal of the first transistor;
a second switch that is connected between the other terminal of the second capacitor and the second electrode of the driving transistor to connect or block a connection between the second capacitor and the second electrode of the driving transistor;
a third switch that is connected between the second electrode of the driving transistor and the first power supply to connect or block the supply of the first power supply voltage to the second electrode of the driving transistor; and
a fourth switch that is connected between a reverse bias power supply and one terminal of the organic light emitting diode to connect or block the reverse bias voltage applied to the organic light emitting diode.

6. The organic light emitting display according to claim 5, wherein when the reverse bias applying signal is applied to the reverse bias voltage applying module, the first switch is turned off and the second to fourth switches are turned on.

7. The organic light emitting display according to claim 6, wherein when the reverse bias applying signal is applied to the reverse bias voltage applying module, second power is supplied to the first electrode of the driving transistor and first power is supplied to the other terminal of the organic light emitting diode.

8. The organic light emitting display according to claim 5, wherein when the reverse bias applying signal is not applied to the reverse bias voltage applying module, the first switch is turned on and the second to fourth switches are turned off.

9. The organic light emitting display according to claim 5, wherein the reverse bias applying signal is applied in a section where the organic light emitting diode is not light-emitted.

10. The organic light emitting display according to claim 5, wherein the second capacitor has the same capacity as the first capacitor.

11. The organic light emitting display according to claim 4, wherein the reverse bias voltage applying module includes:
a first switch that is connected between the other terminal of the first capacitor and the first electrode of the driving transistor to connect or block a connection between the first capacitor and the first electrode of the driving transistor;
a second switch that is connected between the other terminal of the first capacitor and the second electrode of the driving transistor to connect or block a connection between the first capacitor and the second electrode of the driving transistor;
a third switch that is connected between the second electrode of the driving transistor and the first power supply voltage line to connect or block the supply of the first power supply voltage to the second electrode of the driving transistor; and
a fourth switch that is connected between a reverse bias power supply voltage line and one terminal of the organic light emitting diode to connect or block the reverse bias voltage applied to the organic light emitting diode.

12. The organic light emitting display according to claim 11, wherein when the reverse bias applying signal is applied to the reverse bias voltage applying module, the first switch is turned off and the second to fourth switches are turned on.

13. The organic light emitting display according to claim 12, wherein when the reverse bias applying signal is applied to the reverse bias voltage applying module, second power is supplied to the first electrode of the driving transistor and first power is supplied to the other terminal of the organic light emitting diode.

14. The organic light emitting display according to claim 11, wherein when the reverse bias applying signal is not applied to the reverse bias voltage applying module, the first switch is turned on and the second to fourth switches are turned off.

15. The organic light emitting display according to claim 11, wherein when the reverse bias applying signal is applied in a section where the organic light emitting diode is not light-emitted.
